(19) United States
(12) Patent Application Publication
(10) Pub. No.: US 2026/0289930 A1
(43) Pub. Date: Sep. 24, 2026

(54) METHOD AND SYSTEM FOR AUTHORING EXTENDED REALITY CONTENT

(71) Applicant: KOREA INSTITUTE OF SCIENCE & TECHNOLOGY INFORMATION, Daejeon (KR)

(72) Inventors: Jeong Hoon LEE, Daejeon (KR); Sung Hee LEE, Daejeon (KR); Jeong Hun SHIN, Daejeon (KR); Ho Chul LEE, Daejeon (KR); Kum Won CHO, Daejeon (KR)

(73) Assignee: KOREA INSTITUTE OF SCIENCE & TECHNOLOGY INFORMATION, Daejeon (KR)

(21) Appl. No.: 19/681,341

(22) Filed: May 19, 2026

Related U.S. Application Data
(63) Continuation of application No. PCT/KR2024/005470, filed on Apr. 23, 2024.

(30) Foreign Application Priority Data
Nov. 20, 2023 (KR) 10-2023-0161482

(51) Int. Cl. G06T 19/20; G06T 19/00

(52) U.S. Cl. CPC G06T 19/20; G06T 19/006

(57) ABSTRACT

Provided is a method for authoring extended reality content, which authors, using a studio authoring tool, unit content composed of objects and scenes in extended reality (XR, eXtended Reality) content, builds, using a builder, a common framework that is pre-compiled into a program executable on a predetermined device, and links the unit content to the common framework based on execution of the pre-compiled common framework.

### CROSS-REFERENCE TO RELATED APPLICATIONS

This application is a continuation of PCT International Application No. PCT/KR2024/005470 filed on Apr. 23, 2024, which claims priority to Korean Patent Application No. 10-2023-0161482 filed with the Korean Patent Office on Nov. 20, 2023, the entire contents of each of which are incorporated herein by reference for all purposes.

### FIELD

The present disclosure relates to a method and system for authoring extended reality content.

### BACKGROUND

Recently, interest in extended reality encompassing virtual reality (VR), augmented reality (AR), and mixed reality (MR) has been increasing, and accordingly, contents providing extended reality spaces having various purposes are being developed.

In order to provide such extended reality content, solutions are required for various matters for implementing extended reality content, such as rendering techniques for various extended reality implementation devices, network and server operation techniques, and interaction techniques between users or between a user and an object.

For example, extended reality content developed with a specific extended reality implementation device in mind may not be executable on other extended reality implementation devices, and in order to address this problem, compatibility with each of the various extended reality implementation devices must be taken into consideration during the development process of extended reality content.

Meanwhile, the present disclosure was derived as part of the national research and development project ‘Development of Untact(non-face-to-face) Immersive OpenXR Platform Technology’ (Project Unique Number: 1711177182, Project Number: CRC 21011, Ministry: Ministry of Science and ICT, Project Management (Specialized) Institution: National Research Council of Science and Technology, Research Program Name: National Research Council of Science and Technology Research Operating Cost Support (Major Project Cost), Research Project Name: Development of Untact(non-face-to-face) Immersive OpenXR Platform Technology, Contribution Rate: 1/1, Project Performing Institution: Korea Institute of Science and Technology Information, Research Period: 2021.12.01~2027.11.30).

### Technical Problem

The present disclosure relates to an efficient extended reality content authoring method and system that enables users to easily become producers of content.

In addition, the present disclosure relates to an extended reality content authoring method and system for authoring extended reality content by linking a common framework and unit content.

### Technical Solution

In order to solve the problems described above, common functional elements that are each usable in different services are built into a common framework, and a pipeline of extended reality content for authoring unit content corresponding to individual services is established.

More specifically, the method for authoring extended reality content according to the present disclosure may comprise: authoring, using a studio authoring tool, unit content composed of objects and scenes in extended reality (XR, eXtended Reality) content; building, using a builder, a common framework that is pre-compiled into a program executable on a predetermined device; and linking the unit content to the common framework based on execution of the pre-compiled common framework to author the extended reality content.

In addition, a program stored in a computer-readable recording medium according to the present disclosure is executed by one or more processors in an electronic device and stored in a computer-readable recording medium, wherein the program may include instructions that, when executed, cause a processor to perform: authoring, using a studio authoring tool, unit content composed of objects and scenes in extended reality content; building, using a builder, a common framework that is pre-compiled into a program executable on a predetermined device; and linking the unit content to the common framework based on execution of the pre-compiled common framework to author the extended reality content.

### Advantageous Effects

According to various embodiments of the present disclosure, a method and system for authoring extended reality content build common functional elements that are each usable in different services into a common framework and author unit content corresponding to individual services based on the common framework, thereby effectively shortening the development process for implementing extended reality content through a user terminal and enabling more diverse individual services to be developed with ease.

In addition, according to various embodiments of the present disclosure, a method and system for authoring extended reality content author functional elements related to various environments in which extended reality content is implemented as a common framework, thereby enabling authoring of extended reality content executable in various execution environments and, through this, dramatically reducing the difficulty of developing extended reality content.

In addition, according to various embodiments of the present disclosure, a method and system for authoring extended reality content author extended reality content by linking a common framework and unit content, thereby making it easy to link unit content authored in different ways to the same common framework, and through this, enabling easy authoring of extended reality content having various styles.

### BRIEF DESCRIPTION OF THE DRAWINGS

FIG. 1 illustrates an embodiment of extended reality content according to the present disclosure.

FIG. 2 illustrates an embodiment of extended reality content according to the present disclosure.

FIG. 3 illustrates an extended reality content authoring system according to the present disclosure.

FIG. 4 is a flowchart of a method for authoring extended reality content according to the present disclosure.

FIG. 5 illustrates an embodiment of unit content.

FIG. 6 illustrates an embodiment of unit content.

FIG. 7 illustrates an embodiment of unit content.

FIG. 8 illustrates an embodiment of unit content.

FIG. 9 illustrates an embodiment of functional elements included in a common framework.

FIG. 10 illustrates an embodiment in which a common framework and unit content are linked.

FIG. 11 illustrates an embodiment in which a common framework and unit content are linked.

FIG. 12 illustrates an embodiment of a process in which extended reality content is executed.

FIG. 13 illustrates an embodiment of a process in which extended reality content is executed.

### DETAILED DESCRIPTION OF EMBODIMENTS

Hereinafter, embodiments disclosed in the present specification will be described in detail with reference to the accompanying drawings, wherein the same reference numerals are assigned to the same or similar components regardless of reference numerals, and redundant descriptions thereof will be omitted.

The suffixes “module” and “unit” for components used in the following description are given or used interchangeably in consideration of ease of drafting the specification only, and do not have meanings or roles that are distinguished from each other by themselves.

In addition, in describing the embodiments disclosed in the present specification, if it is determined that a detailed description of related known technology may obscure the gist of the embodiments disclosed in the present specification, the detailed description thereof will be omitted.

In addition, the accompanying drawings are provided only to facilitate understanding of the embodiments disclosed in the present specification, and the technical idea disclosed in the present specification is not limited by the accompanying drawings, and it should be understood that all modifications, equivalents, and substitutes included in the spirit and technical scope of the present disclosure are included.

Terms including ordinal numbers such as first, second, etc. may be used to describe various components, but the components are not limited by the terms.

The terms are used only for the purpose of distinguishing one component from another component.

When a component is referred to as being “connected” or “coupled” to another component, it should be understood that the component may be directly connected or coupled to the other component, but another component may also exist in between.

On the other hand, when a component is referred to as being “directly connected” or “directly coupled” to another component, it should be understood that no other component exists in between.

Singular expressions include plural expressions unless the context clearly indicates otherwise.

In the present application, terms such as “comprise” or “have” are intended to designate the existence of a feature, number, step, operation, component, part, or combination thereof described in the specification, and should be understood as not precluding in advance the possibility of the existence or addition of one or more other features, numbers, steps, operations, components, parts, or combinations thereof.

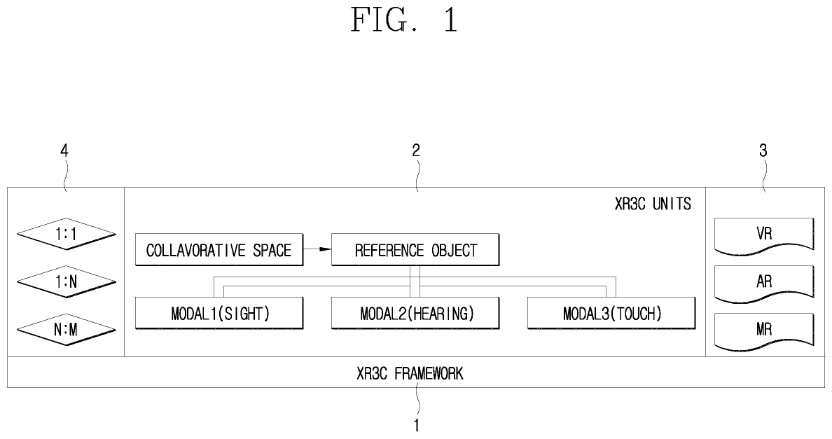

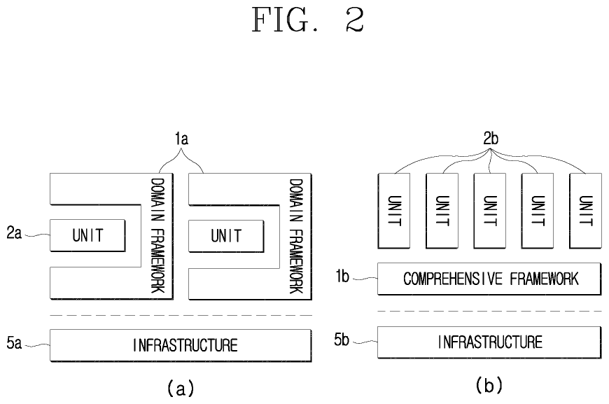

FIGS. 1 to 2 illustrate an embodiment of extended reality content according to the present disclosure.

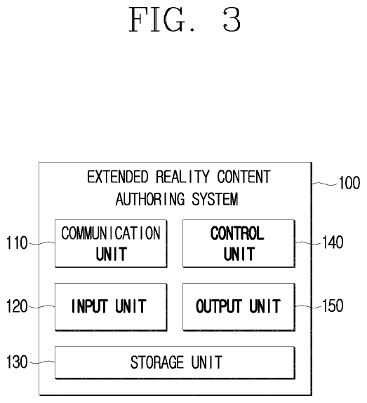

FIG. 3 illustrates an extended reality content authoring system according to the present disclosure.

Referring to FIG. 1, the extended reality content authoring system according to the present disclosure builds a common framework (1) that is pre-compiled into a program executable on a predetermined device using a builder, and may author unit content composed of objects and scenes in extended reality (XR, eXtended Reality) content using a studio authoring tool.

Here, the extended reality content may include scenes (e.g., virtual spaces) based on extended reality, including virtual reality (VR, Virtual Reality), augmented reality (AR, Augmented Reality), and mixed reality (MR, Mixed Reality), and one or more objects placed in the scene.

Accordingly, the extended reality content may be implemented to be executed through a user terminal to render scenes and one or more objects, and to perform a predetermined interaction based on a user input to an object.

For example, when the extended reality content is implemented to perform communication among a plurality of users, it may be implemented to realize, as an object, an avatar for a user who has accessed the extended reality content through a user terminal on a scene, and as an example of interaction, to transmit a message to the user terminal of another user or to perform a voice call or a video call based on a user input to the avatar of the other user.

As another example, when the extended reality content is implemented to assist a user's health condition, it may be implemented to realize, as objects, a plurality of objects having different shapes on a scene, and as an example of interaction, to calculate a score for the user's health condition based on a user input to any one of the plurality of objects.

As yet another example, when the extended reality content is implemented to perform education targeting a specific user, it may be implemented to realize, as objects, one or more objects necessary for education on a scene, and as an example of interaction, to execute shape transformation, position movement, and rotation of an object according to a predetermined algorithm based on a user input to the one or more objects.

As another example, when the extended reality content is implemented to arrange furniture in a predetermined area, it may be implemented to realize, as objects, one or more pieces of furniture to be arranged in the predetermined area, and as an example of interaction, to provide information such as dimensions of the corresponding area based on a user input to the predetermined area in the virtual space, and to arrange the corresponding furniture in the predetermined area based on a user input to the furniture.

Such extended reality content may be implemented to be provided through user terminals such as tablets, personal computers, smartphones, and wearable devices, and for example, the extended reality content may be provided in the form of an application or software, or may be provided on a web page.

In this case, the user terminal may be referred to as a tablet, personal computer, smartphone, wearable device, or the like, and may be connected to a device capable of outputting a scene implemented as a virtual reality space, an augmented reality space, a mixed reality space, or an extended reality space, to provide a scene according to the extended reality content.

In addition, the user terminal may also be a device that provides virtual reality, augmented reality, mixed reality, or extended reality.

For example, the user terminal may be a head mounted display (HMD) worn on the head, but this is merely an example, and other types of devices may also be possible.

Meanwhile, the common framework may be one in which common functional elements that are each usable in different services are implemented as a framework app.

In this case, a functional element may be an element commonly included in a plurality of extended reality content items belonging to the same service field.

That is, a functional element is a kind of template for extended reality content, and may include, depending on the embodiment, information for rendering extended reality content on a user terminal, information for recognizing a user input in the extended reality content, information for placing an object in a scene of the extended reality content, and information for executing an interaction with an object based on a user input.

Accordingly, a functional element is implemented in the form of a function that executes a specific interaction or performs a specific function, and may include attributes for resources such as textures, character strings, and animations, and a resource database (Resource DB) in which commonly used resources are stored.

In addition to the above, a functional element may include various information required to implement different extended reality content.

For example, a functional element may include an element for rendering extended reality content according to the type of virtual reality environment (3) supported by the user terminal (e.g., a virtual reality environment, an augmented reality environment, a mixed reality environment, and an extended reality environment), and an element for processing networks and data according to the connection type (4) of the extended reality content.

In this case, the connection type (4) of the extended reality content may include a one-to-one handshaking type of a speaker-receiver relationship, a one-to-many broadcasting type, and a many-to-many multicasting type.

As another example, when the extended reality content is implemented to perform communication among a plurality of users, a functional element may include a functional element for creating a chat room, a functional element for providing a voice call between users participating in the chat room, and a functional element for providing information related to users participating in the chat room.

As yet another example, when the extended reality content is implemented to assist a user's health condition, a functional element may include a functional element for determining a score related to the user's health condition, a functional element for recognizing a user input through an object implemented in a virtual space, and a functional element for performing shape transformation, position movement, and rotation of an object implemented in the virtual space based on a user input.

As another example, when the extended reality content is implemented to perform education targeting a specific user, a functional element may include a functional element for providing the user with information related to an object implemented in a virtual space, a functional element for performing shape transformation, position movement, and rotation of the object according to a predetermined algorithm, and a functional element for controlling the rate of change of state of the object in the virtual space.

As yet another example, when the extended reality content is implemented to arrange furniture in a predetermined area, a functional element may include a functional element for designating an area in a virtual space, a functional element for arranging one or more pieces of furniture in the pre-designated area, a functional element for displaying one or more pieces of furniture that can be arranged in the pre-designated area, and a functional element for transforming the shape, position, and orientation of furniture.

The functional elements as described above may be implemented in the form of a common framework (1) executable on a user terminal.

That is, the common framework (1) may be a kind of extended reality content that includes only functional elements.

Through this, a user may implement an extended reality-based scene using functional elements included in the common framework (1).

In this regard, the builder may be implemented to build the common framework.

That is, the builder may author functional elements that are each usable in different services as extended reality content, and perform pre-compilation on the functional elements to build the common framework.

Meanwhile, an object may be an element implemented to be recognizable by a user based on functional elements included in the common framework (1).

That is, an object is an element implemented using the common framework (1) containing functional elements, and may include, depending on the embodiment, information related to an interaction executed in response to a user input, information related to the shape and position of an object displayed through a user terminal, and information related to a background image of a virtual space.

Accordingly, an object is implemented in the form of a callback function that calls functional elements included in the common framework (1), and may include functions that define external resources such as textures, character strings, and animations.

In addition to the above, an object may include various information implemented to allow a user to experience extended reality content through a user terminal.

For example, when the extended reality content is implemented to perform communication among a plurality of users, an object may include an element for distinguishing chat rooms created by other users, an element for distinguishing a plurality of users participating in a chat room, and an element related to a location where information related to other users is displayed through a user terminal.

As another example, when the extended reality content is implemented to assist a user's health condition, an object may include an element related to a location where a score calculated in relation to the user's health condition is displayed, and an element related to the shape and position of an object implemented in a virtual space for recognizing a user input.

As yet another example, when the extended reality content is implemented to perform education targeting a specific user, an object may include an element related to the initial shape, state, and position of an object implemented in a virtual space, and an element related to the next shape, state, and position of the object on which an interaction has been executed based on a user input.

As another example, when the extended reality content is implemented to arrange furniture in a predetermined area, an object may include an element for displaying a pre-designated area in a virtual space, an element for displaying an area within the predetermined area in which a specific piece of furniture can be arranged, and an element related to the shape of one or more predetermined pieces of furniture.

Objects such as those described above may be implemented in the form of unit content (2) based on the common framework (1).

That is, the unit content (2) includes information related to one or more objects for the extended reality content, and may be authored to include objects and scenes corresponding to each individual service for different services.

In this regard, the studio authoring tool may be implemented to author unit content (2) by composing objects and scenes implemented in the extended reality content.

That is, the studio authoring tool may author unit content by generating objects and scenes in the extended reality content based on the common framework.

Accordingly, the extended reality content authoring system may author extended reality content by installing unit content (2) in the common framework (1), and may easily implement different extended reality content by installing each unit content (2) containing different objects in the same common framework (1).

In this case, the extended reality content authored by the extended reality content authoring system may be named a domain framework composed of the common framework (1) and the unit content (2), and such a domain framework may be expanded into a comprehensive framework in which common functional elements that can be commonly applied in a specific service field and different unit content are installed.

In some embodiments, when the extended reality content includes UI, Object, Space, Interaction, and Device Control, the functional elements and the objects may each include at least one of the components included in the extended reality content.

The components included in such functional elements and objects may vary depending on the service field or service purpose of the extended reality content.

In another embodiment, a functional element of the extended reality content is implemented in the form of a function that performs a specific function, and an object may be implemented as code having the form of a callback function that calls a function according to the functional elements included in the common framework.

Accordingly, referring to FIG. 2(a), the extended reality content authoring system may author extended reality content by installing unit content (2a) implemented based on each common framework (1a) into different common frameworks (1a) implemented for each service field.

In this case, each common framework (1a) may be implemented based on an operating system (or Infrastructure (5a)) installed on a user terminal.

In addition, referring to FIG. 2(b), the extended reality content authoring system may also author different extended reality content based on one common framework (1b) by installing different unit content (2b) implemented based on the same common framework (1b) into the common framework (1b), respectively.

In this case, the common framework (1b) may be implemented based on an operating system (or Infrastructure (5b)) installed on a user terminal.

Through the configurations described above, the extended reality content authoring system according to the present disclosure may author extended reality content by authoring objects based on the common framework (1) implemented to author extended reality content, and installing unit content (2) containing the authored objects into the framework (1).

To this end, the extended reality content authoring system (100) according to the present disclosure may include a communication unit (110), an input unit (120), a control unit (130), an output unit (140), and a storage unit (150).

The communication unit (110) may be connected to any external device through a wired or wireless network.

Accordingly, the communication unit (110) may receive a common framework from an external device (e.g., a management server, etc.).

In addition, the communication unit (110) may transmit extended reality content authored to an external device (e.g., another user terminal), or may receive unit content (or objects) generated by an external device.

The input unit (120) may recognize a user input to the extended reality content authoring system (100).

For example, the input unit (120) may recognize a user input for generating an object (or a functional element).

The storage unit (150) may store various information and instructions required for the operation of the extended reality content authoring system (100) according to the present disclosure.

For example, the storage unit (150) may store the common framework and unit content.

That is, the storage unit (150) may store functional elements and objects.

The control unit (130) may control the overall operation of the extended reality content authoring system (100) according to the present disclosure.

For example, the control unit (130) may author unit content (or objects) based on the common framework based on a user input.

In addition, the control unit (130) may author extended reality content by installing unit content (or objects) in the common framework.

To this end, the control unit (130) may compile unit content based on the common framework.

In addition, the control unit (130) may generate a functional element based on a user input and author the common framework.

The output unit (140) may display the extended reality content so that a user can confirm it.

In addition, the output unit (140) may display information generated in the process of generating at least one of a functional element and an object.

Based on the configuration of the extended reality content authoring system (100) reviewed above, the method for authoring extended reality content will be described in more detail below.

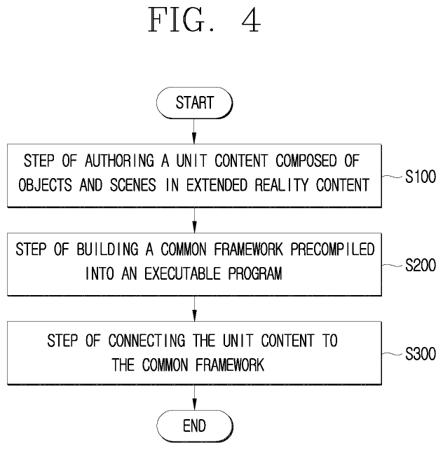

FIG. 4 is a flowchart of a method for authoring extended reality content according to the present disclosure.

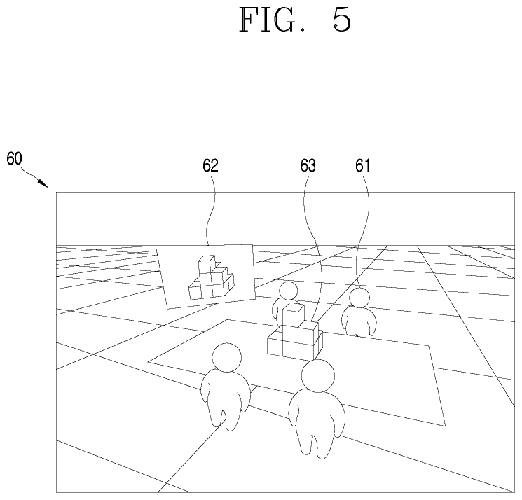

FIGS. 5 to 8 illustrate an embodiment of unit content.

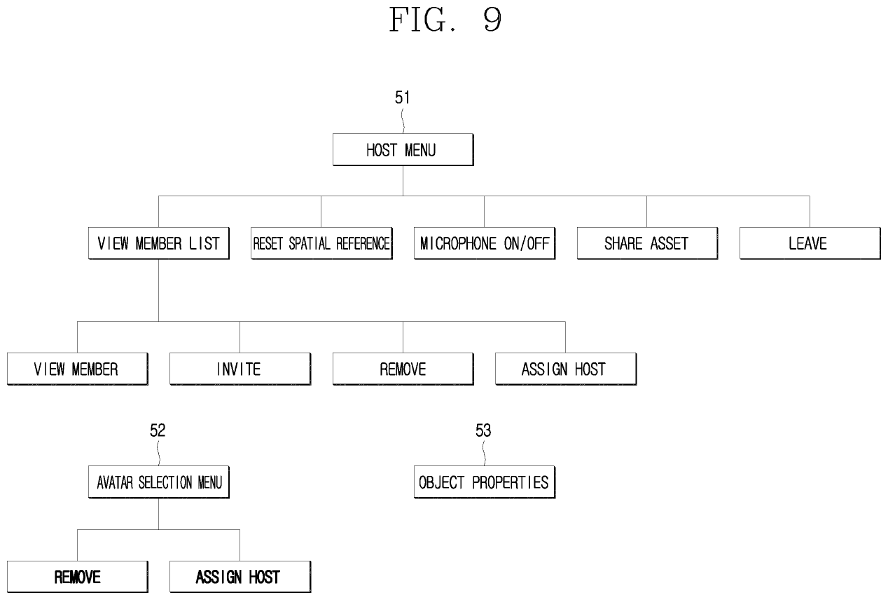

FIG. 9 illustrates an embodiment of functional elements included in a common framework.

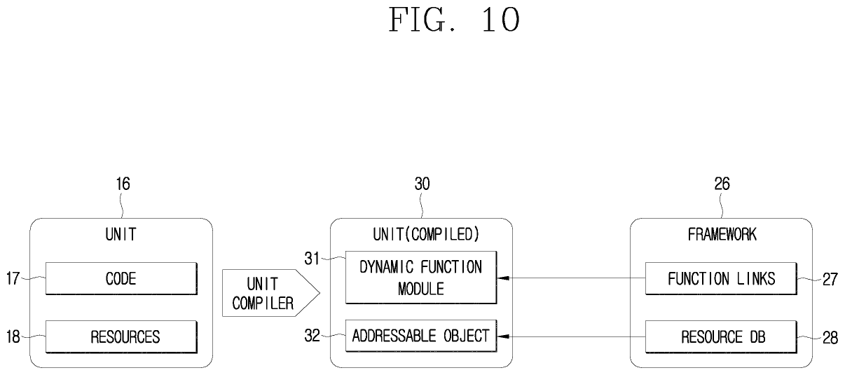

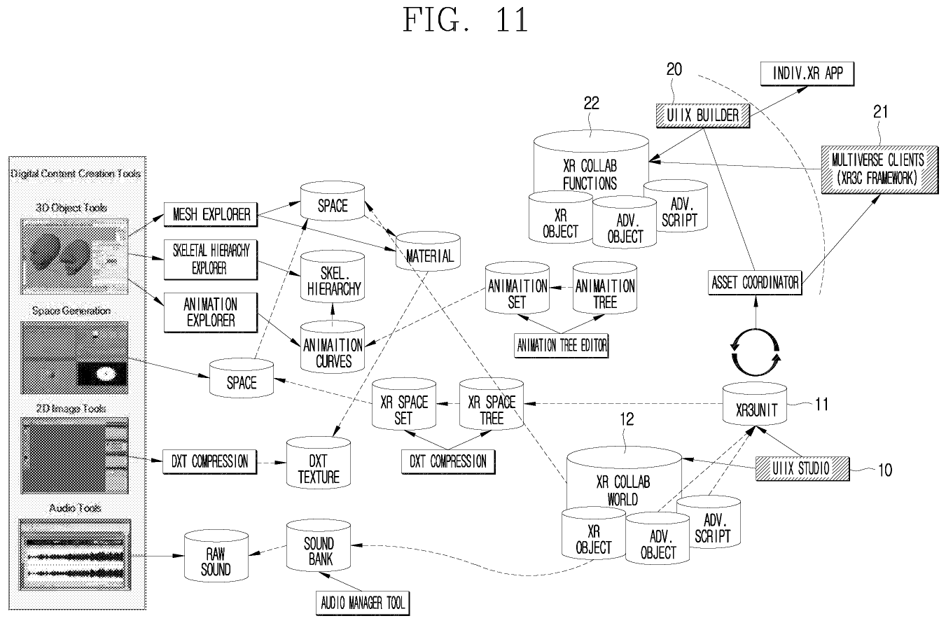

FIGS. 10 and 11 illustrate an embodiment in which a common framework and unit content are linked.

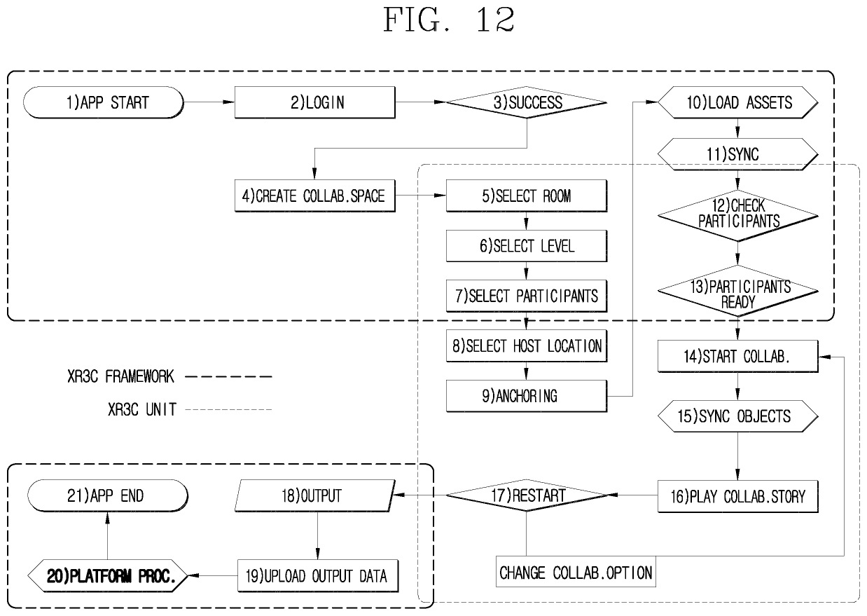

FIG. 12 illustrates an embodiment of a process in which extended reality content is executed.

First, a new pipeline for authoring extended reality content proposed in the present disclosure will be described with reference to FIG. 4.

The pipeline consists of a process of building common functional elements that are each usable in different services into a common framework, authoring unit content corresponding to each individual service, and linking the common framework and the unit content.

To this end, the extended reality content authoring system (100) according to the present disclosure may author unit content composed of objects and scenes in extended reality content using a studio authoring tool (S100).

Specifically, the extended reality content authoring system (100) may load an object into the studio authoring tool based on execution of the studio authoring tool, and place the object in a scene based on a user input.

For example, the extended reality content authoring system (100) may author collaborative context interaction by designating attributes or multimodal properties of an object related to collaboration, based on a common framework built to provide a collaboration-related service.

In this regard, the present disclosure may be utilized as an extended reality content authoring model centered on the purpose of a collaborative service, which enables efficient content authoring by distinguishing between collaborative functional elements and target elements in extended reality.

For example, when a collaboration participant directly authors content used for collaboration, a large amount of professional knowledge and skills are required for authoring extended reality content, making it difficult to provide an easy authoring environment.

However, the authoring model according to the present disclosure separates functional elements (e.g., the common framework) and target elements (e.g., unit content), thereby enabling an authoring environment in which participants in collaboration who do not have professional content authoring skills can easily participate as collaboration content producers even for extended reality collaboration services that include complex functional elements.

Meanwhile, multimodal may be one that defines at least one of an input method and an output method for extended reality content.

That is, multimodal refers to at least one of various input methods and output methods, and depending on the embodiment, multimodal may refer to a position input method using a mouse, a touch pad, or the like, a voice input method using a microphone or the like, a text input method using a keyboard or the like, a voice output method using a speaker or the like, a tactile output method using a haptic device or the like, and a visual output method using a monitor, a TV, or the like.

In addition, the extended reality content authoring system (100) may author collaborative context interaction by designating attributes or multimodal properties of objects related to various services, such as architecture-related services, education-related services, interior design-related services, and entertainment-related services, in addition to collaboration-related services.

As another example with reference to FIG. 5, the extended reality content authoring system (100) may author unit content for stacking blocks (63) according to an example image (62) by placing an avatar (61), an example image (62), and blocks (63) in a scene (60) generated by the studio authoring tool.

In this case, the extended reality content authoring system (100) may utilize, based on the common framework, functional elements related to manipulation of the avatar (61), and functional elements related to object attributes of the example image (62) and the blocks (63).

In addition, the extended reality content authoring system (100) may author unit content by using the studio authoring tool to designate the position and form of the avatar (61), designate the position, size, and image file of the example image (62), and designate the form, position, and interaction method of the blocks (63).

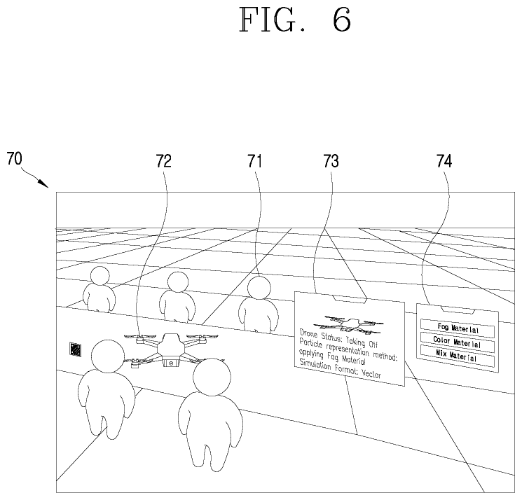

As yet another example with reference to FIG. 6, the extended reality content authoring system (100) may author unit content that provides education on the composition and functions of a learning object (72) by manipulating an information display panel (73), by placing an avatar (71), a learning object (72), and an information confirmation window (73) in a scene (70) generated by the studio authoring tool.

In this case, the extended reality content authoring system (100) may utilize, based on the common framework, functional elements related to manipulation of the avatar (71), and functional elements related to object attributes of the learning object (72) and the information display panel (73).

In addition, the extended reality content authoring system (100) may author unit content by using the studio authoring tool to designate the position and form of the avatar (71), designate the position, size, and animation motion of the learning object (72), and designate the form, position, image, text string, and interaction method of the information display panel (73).

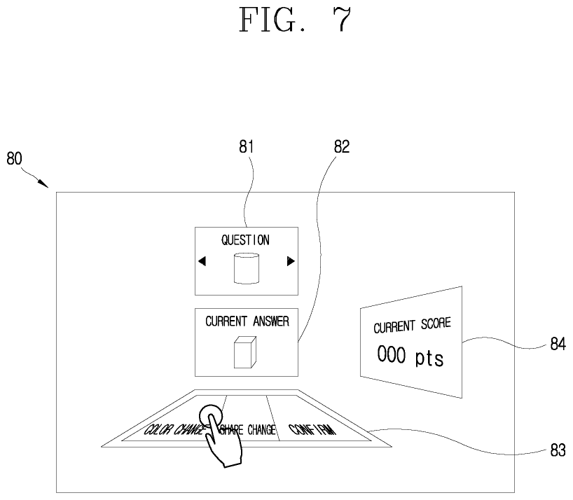

As another example with reference to FIG. 7, the extended reality content authoring system (100) may author unit content for changing the image of an answer display panel (82) into the same form as the image displayed in a question display panel (81) by manipulating an interaction menu (83), by placing a question confirmation window (81), an answer confirmation window (82), an interaction menu (83), and a score display panel (84) in a scene (80) generated by the studio authoring tool.

In this case, the extended reality content authoring system (100) may utilize, based on the common framework, functional elements related to manipulation of the interaction menu (83), and functional elements related to object attributes of the question display panel (81), the answer confirmation window (82), the interaction menu (83), and the score confirmation window (84).

In addition, the extended reality content authoring system (100) may author unit content by using the studio authoring tool to designate the position, form, and image file of the question display panel (81), designate the position, size, image file, and animation motion of the answer confirmation window (82), designate the form, position, text string, and interaction method of the interaction menu (83), and designate the position, size, image file, and animation motion of the score confirmation window (84).

Furthermore, the extended reality content authoring system (100) may author story content that configures transitions of scenes by placing objects in a plurality of scenes and designating relationships among the plurality of scenes in which the objects are respectively placed.

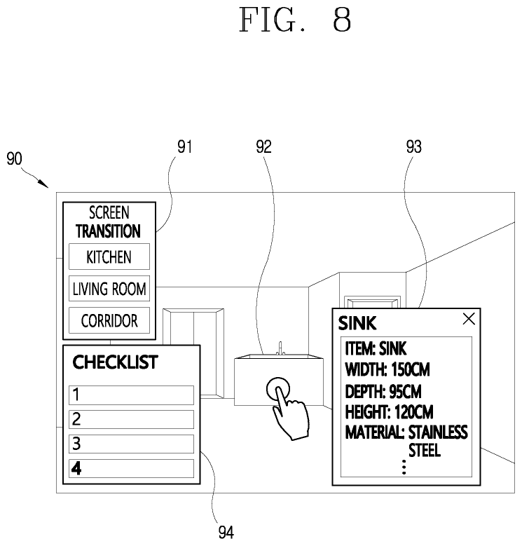

As an example with reference to FIG. 8, the extended reality content authoring system (100) may author unit content that places a predetermined furniture object (92) in each of a plurality of scenes (90) and provides a furniture information window (93) related to the placed furniture object (92), by placing a scene navigation menu (91), a furniture object (92), a furniture information window (93), and a mission display panel (94) in a plurality of scenes (90) generated by the studio authoring tool.

In this case, the extended reality content authoring system (100) may utilize, based on the common framework, functional elements related to transitions among the plurality of scenes (90) according to the scene navigation menu (91), functional elements related to manipulation of the scene navigation menu (91), the furniture object (92), the furniture information window (93), and the mission display panel (94), and functional elements related to object attributes.

In addition, the extended reality content authoring system (100) may author unit content by using the studio authoring tool to designate the position, form, text string, and interaction method of the scene navigation menu (91), designate the position, form, texture image, and interaction method of the furniture object (92), designate the position, form, and text string of the furniture information window (93), and designate the position, form, and interaction method of the mission display panel (94).

Furthermore, the extended reality content authoring system (100) according to the present disclosure may build, using a builder, a common framework that is pre-compiled into a program executable on a predetermined device (S200).

Specifically, the extended reality content authoring system (100) may author functional elements that are each usable in different services, based on a user input.

For example, the extended reality content authoring system (100) may author functional elements related to at least one of data interworking, avatar synchronization, and synchronization of a collaboration space through the builder.

As another example with reference to FIG. 9, the extended reality content authoring system (100) may author functional elements related to at least one of a host menu (51), an avatar selection menu (52), and object attributes (53) through the builder.

In this case, the extended reality content authoring system (100) may also author sub-functional elements (or detailed functional elements) related to each functional element through the builder.

That is, the extended reality content authoring system (100) may author, as sub-functional elements for the functional element related to the host menu (51), functional elements related to at least one of member list confirmation, space reference reset, microphone on/off, asset sharing, and exit, and may author, as sub-functional elements for the functional element related to the avatar selection menu (52), functional elements related to at least one of export and host delegation.

In addition, the extended reality content authoring system (100) may author sub-functional elements for sub-functional elements again, such as member inquiry, invitation, export, and host delegation, which are sub-functional elements for member list confirmation.

Furthermore, the extended reality content authoring system (100) may build the common framework as a program executable on a predetermined device by performing pre-compilation on the previously authored functional elements using the builder.

The extended reality content authoring system (100) according to the present disclosure may link the unit content to the common framework based on execution of the pre-compiled common framework to author the extended reality content (S300).

Specifically, the extended reality content authoring system (100) may author unit content using the studio authoring tool, compile the unit content into a code part and a resource part through a unit compiler, and link the compiled unit content to the common framework.

As an example with reference to FIG. 10, the extended reality content authoring system (100) may implement the code (17) of the unit content (16) as a callback function connectable to the functional element (27) of the common framework (26) using the studio authoring tool, and convert the code (17) of the unit content (16) into a dynamic program element (31) (or a dynamic functional element) through compilation (30) of the unit content (16).

In this case, the extended reality content authoring system (100) may convert the resource (18) of the unit content (16) into an object (32) that is dynamically referenceable through the resource database (28) of the common framework (26).

As another example with reference to FIG. 11, the extended reality content authoring system (100) may build a common framework (21) including functional elements (22) related to extended reality content using a builder (20) (e.g., UIIX Builder).

In addition, the extended reality content authoring system (100) may load at least one of scenes and objects (12) authored using various digital content creation tools (Digital Content Creation Tools) using the studio authoring tool (10) (e.g., UIIX Studio).

To this end, at least one of the scenes and objects (12) may be authored based on the common framework (21), or may be converted to be compatible with the common framework (21) through the studio authoring tool (10).

Accordingly, the extended reality content authoring system (100) may author unit content (11) (e.g., XR3C Unit) by placing objects (12) in an arbitrary scene through the studio authoring tool (10).

Subsequently, the extended reality content authoring system (100) may link (or install) the unit content (11) to the common framework (21) through compilation of the unit content (11).

In this case, the extended reality content authoring system (100) may convert at least one of the scenes and objects (12) to be compatible with the common framework (21).

Furthermore, the extended reality content authoring system (100) may generate an extended reality application that is installed on a specific device and runs the extended reality content, using the common framework and the unit content linked through compilation.

For example, the extended reality content authoring system (100) may generate an extended reality application for each specific service by linking unit content corresponding to the specific service to the common framework in the builder (or the studio authoring tool).

As another example, the extended reality content authoring system (100) may generate the common framework as a common application in the builder (or the studio authoring tool), and generate an extended reality application to provide a corresponding service as unit content corresponding to the specific service is installed in the common application.

Meanwhile, referring to FIG. 12, an embodiment of a process in which extended reality content authored to provide a service related to a collaborative meeting is executed can be confirmed.

Depending on the embodiment, in the extended reality content, at least one of the functional elements included in the common framework and the objects included in the unit content may be loaded (or executed) based on the operation of the extended reality application.

For example, operations such as execution (App Start), termination (App End), user login (Login), and asset (or object) loading (Load Assets) of the extended reality application may be executed by functional elements included in the common framework, and operations such as selecting a host location (Select Host Location) and anchoring the space in which the host is located and the virtual space of the extended reality content may be implemented such that a callback function that calls a specific functional element is executed by an object of the unit content.

Through the configurations described above, the extended reality content authoring system (100) according to the present disclosure can effectively shorten the development process for implementing extended reality content through a user terminal and can easily develop a wider variety of individual services, by building common functional elements that are each usable in different services into a common framework and authoring unit content corresponding to each individual service based on the common framework.

In particular, the extended reality content authoring system (100) according to the present disclosure can author extended reality content executable in various execution environments by authoring functional elements related to various environments in which extended reality content is implemented as a common framework, and through this, can dramatically lower the difficulty of developing extended reality content.

In addition, the extended reality content authoring system (100) according to the present disclosure makes it easy to link unit content authored in different ways to the same common framework by authoring extended reality content by linking the common framework and the unit content, and through this, can easily author extended reality content having various styles.

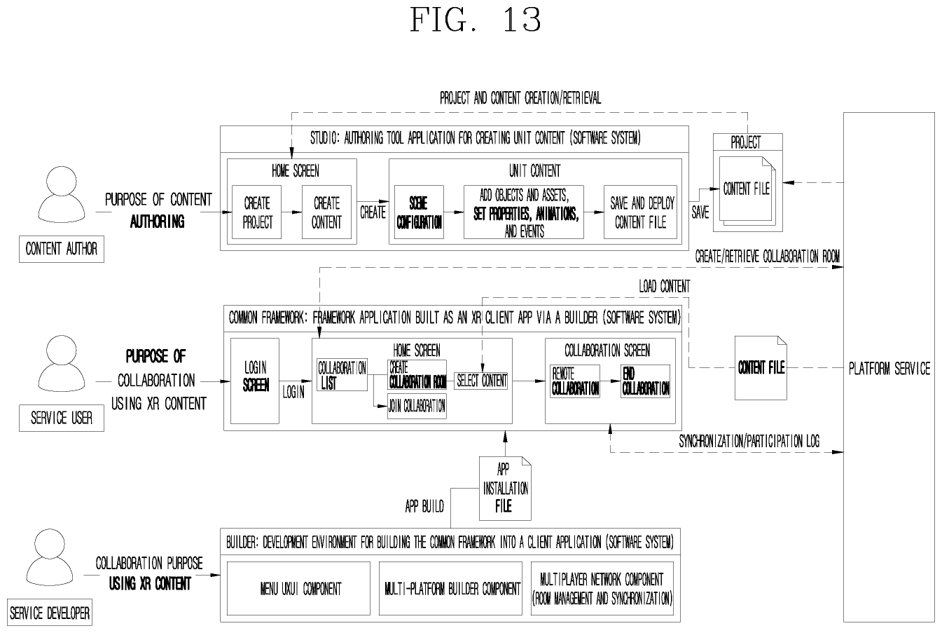

As a more specific embodiment, referring to FIG. 13, a pipeline according to an embodiment of the extended reality content authoring system (100) can be confirmed.

According to this, the extended reality content authoring system (100) may build a common framework based on a builder, based on a user input by a developer.

In this case, the builder may be implemented to provide a development environment in which the common framework is built and the built common framework can be built into a client app.

That is, the builder may be implemented to build a common framework including various functional elements such as menu UX (User eXperience)/UI (User Interface) components, multi-platform builder components, and multi-player networking components.

Meanwhile, the extended reality content authoring system (100) may build unit content based on a studio authoring tool, based on a user input by a content author.

In this case, the studio authoring tool may be implemented to provide an authoring environment capable of generating unit content and converting the generated unit content into a content file that can be installed in a client app.

That is, the studio authoring tool may be implemented to author unit content including various target elements such as a home screen, scene composition, objects and assets, attributes corresponding to objects and assets, animations, and events.

In this regard, the extended reality content authoring system (100) may be linked to a platform service capable of sharing content files converted from various unit content.

Accordingly, the extended reality content authoring system (100) may, based on a user input by a content author, add a specific project shared in the platform service to unit content as a target element, or upload at least some target elements included in authored unit content to the platform service to share with other content authors.

In addition, the extended reality content authoring system (100) may be implemented such that a service user downloads various unit content, installs it in a client app, and executes it, by uploading content files converted from unit content to the platform service.

That is, the extended reality content authoring system (100) may execute content by installing a content file downloaded from the platform service in a client app (or a common framework) based on a user input by a service user.

To this end, the extended reality content authoring system (100) may access the platform service through a client app (or a common framework), select any one of a plurality of unit content uploaded to the platform service based on a user input, download the corresponding unit content, and install and execute it in the client app.

Furthermore, the present disclosure described above may be implemented as a program executed by one or more processors in an electronic device and stored in a computer-readable recording medium.

Accordingly, the present disclosure can be implemented as computer-readable code or instructions in a medium on which a program is recorded.

That is, various control methods according to the present disclosure may be provided in the form of an integrated or individual program.

Meanwhile, a computer-readable medium includes all types of recording devices in which data that can be read by a computer system is stored.

Examples of computer-readable media include HDD (Hard Disk Drive), SSD (Solid State Drive), SDD (Silicon Disk Drive), ROM, RAM, CD-ROM, magnetic tape, floppy disk, optical data storage device, and the like.

Furthermore, a computer-readable medium may be a server or cloud storage that includes storage and is accessible by an electronic device through communication.

In this case, a computer may download the program according to the present disclosure from a server or cloud storage through wired or wireless communication.

Furthermore, in the present disclosure, the computer described above is an electronic device equipped with a processor, that is, a CPU (Central Processing Unit), and no particular limitation is placed on the type thereof.

Meanwhile, the detailed description above should not be construed as restrictive in all respects and should be considered as illustrative.

The scope of the present disclosure should be determined by a reasonable interpretation of the appended claims, and all modifications within the equivalent scope of the present disclosure are included in the scope of the present disclosure.

1. A method of authoring extended reality content, comprising: authoring, using a studio authoring tool, unit content composed of objects and scenes in extended reality (XR, eXtended Reality) content; building, using a builder, a common framework that is pre-compiled into a program executable on a predetermined device; and linking the unit content to the common framework based on execution of the pre-compiled common framework to author the extended reality content.

2. The method of claim 1, wherein the unit content is authored using the studio authoring tool, compiled into a code part and a resource part through a unit compiler, and linked to the common framework.

3. The method of claim 2, wherein the code is implemented as a callback function connectable to the common framework and converted into a dynamic program element through the compilation, and the resource is converted into an object that is dynamically referenceable through a resource database (Resource DB) of the common framework.

4. The method of claim 1, wherein the common framework is implemented as a framework app having common functional elements that are each usable in different services.

5. The method of claim 4, wherein the unit content is authored to include the objects and the scenes corresponding to each individual service for the different services.

6. The method of claim 1, wherein authoring the unit content comprises: loading the object into the studio authoring tool based on execution of the studio authoring tool; authoring story content by placing the object in the scene and configuring transitions of the scene; and authoring collaborative context interaction by designating attributes or multimodal properties of the object related to collaboration.

7. The method of claim 6, wherein building the common framework comprises authoring, through the builder, at least one of data interworking, avatar synchronization, and synchronization of a collaboration space.

8. The method of claim 1, further comprising generating an extended reality application that runs the extended reality content and is installed on the device.

9. The method of claim 8, wherein the extended reality application is generated for each specific service by linking unit content corresponding to the specific service to the common framework in the builder, or is generated as a common application in the builder to provide the specific service as unit content corresponding to the specific service is installed in the common application.

10. A program executed by one or more processors in an electronic device and stored in a computer-readable recording medium, wherein the program comprises instructions that, when executed, cause a processor to perform: authoring, using a studio authoring tool, unit content composed of objects and scenes in extended reality content; building, using a builder, a common framework that is pre-compiled into a program executable on a predetermined device; and linking the unit content to the common framework based on execution of the pre-compiled common framework to author the extended reality content.
